(19) United States
(12) Patent Application Publication
(10) Pub. No.: US 2006/0049106 A1
(43) Pub. Date: Mar. 9, 2006

(54) Method and arrangement in maing of mechanical pulp

(75) Inventors: Pasi Nurminen, Raisio (IT); Timo Sutela, Naantali (FI); Kimmo Koskinen, Raisio (FI)

Correspondence Address: OLIFF & BERRIDGE, PLC, P.O. BOX 19928, ALEXANDRIA, VA, 22320, US

(73) Assignee: METSO PAPER, INC., Helsinki (FI)

(21) Appl. No.: 10/535,570

(22) PCT Filed: Nov. 19, 2003
(86) PCT No.: PCT/FI03/00883

§ 371 Date: Jul. 6, 2005

(30) Foreign Application Priority Data
Nov. 20, 2002 (FI) 20022068

(51) Int. Cl. B01D 61/00

(52) U.S. Cl. 210/651; 210/805; 210/167; 210/259; 210/335; 210/195.2; 162/190; 162/29

(57) ABSTRACT

The object of the present invention is a method and arrangement in making of mechanical pulp to reduce the amount of organic dissolved and colloidal substances in the pulp making process water by treating a part of the process water. According to the method the treating is carried out by leading the process water filtrate, separated from the pulp by a press located before bleaching, to pre-treatment, where elongated fibres are fractionated from the process water to be treated. The filtrate that has passed the pre-treatment is led to membrane filtration, where at least part of the organic dissolved and colloidal substances included in the process water are separated from the rest of the process water. The membrane filtration concentrate i.e. the colloidal and dissolved substances separated from the process water, is led to further treatment and the permeate i.e. the process water that has passed the membrane filtration is led back to the pulp making process. An arrangement according to the present invention comprises means to carry out the method according to the invention.

The object of the present invention is a method and arrangement in making of mechanical pulp, which is presented in the preambles of the independent claims presented below.

When making mechanical pulp, i.e. defibering, used in the manufacture of wood based fibre webs, such as paper and board webs, 20-50 kg of substances derived from wood are dissolved or dispersed from the wood per mass ton. The substances derived from wood are accumulated into the pulp making process. These substances derived from wood are generally called dissolved and colloidal substances (DCS).

The compound groups derived from wood and dissolved in white water in making of mechanical pulp typically are: carbohydrates, lignin, fat-soluble extractives (resin, pitch) and inorganic salts (ash). Fat-soluble extractives are colloidal, whereas carbohydrates and lignin are dissolved compounds.

Extractives are released from the wood in the making of mechanical pulp when defibering the wood, for example, by grinding or refining. Anionic interfering substances are hemicelluloses of wood being freed in defibering of wood. In pulp bleaching the composition of hemicelluloses changes and the anionic load of the pulp after bleaching is considerably higher than before bleaching. More substances derived from wood are dissolved into the white water from refined mechanical pulp than from ground pulp, but the composition of DCS is typically almost the same in both cases.

The dissolved and colloidal substances constitute deposits with inorganic salts, which stain the paper and board manufacturing process. Dissolved sugars are also good nutrition for bacteria and thus increase microbiological problems in the process. These factors easily cause decreasing runnability of the paper machine, increase washing interruptions and consumption of wet end chemicals and decrease the quality of the end product. Odour problems are also possible. In order to prevent these problems from becoming so great that the operation of the process is hindered, a typical solution to remove the problem is to change the water, i.e. removing the pulp making process water containing interfering substances and replacing it with new cleaner water.

On the other hand, the increase in attention paid to environmental factors and the tightening of conditions for environmental permits have resulted in the tendency to decrease the use of fresh water in paper and board manufacturing processes. However, the decreased use of fresh water increases the amount of dissolved and colloidal substances in water circulations and therefore further disturbs paper and board manufacturing and lowers the quality of the end product.

If the consumption of fresh water in the paper and board machine is lowered to such a level where the amount of replacement water pumped to the pulp section is insufficient, it cannot be led out of the process either. Therefore, the reuse of water inside the process needs to be increased. However, the wood to be defibrated and bleached brings constantly along more interfering substances whereupon their content accumulates quickly. The risk of deposits in mechanical pulp making then increases considerably. One typical solution to rectify the situation is to use chemicals, but it is often impossible in practice or at least the costs are unreasonably high. In addition, because increasing the use of fresh water to decrease the interfering substance content by diluting is not possible, the amount of effluent increases. The problem with the increased amount of effluent is the difficulty in purifying it, whereupon consequences may be impurities being discharged to the environment and the risk is eutrophication of the waterways.

Typically, to prevent the dissolved and colloidal substances formed during the making of mechanical pulp being carried to the paper or board machine, pulp thickening and washing or washings are used. The pulp wash is performed as a displacement wash, whereupon the pulp is diluted to approximately 5% consistency with so called wash water and pressed after dilution to over 30% consistency. In the pressing, in other words, in washing, most of the DCS are removed from the pulp with the water. Depending on the mill and process configuration the wash press water is led back to the early stages of the pulp making process by counterflow principle and/or out of the process to the effluent treatment. The water used in the wash is usually a mixture of the paper and board mill's white water (clear filtrate) and the press stage's own filtrate.

The quality of wash water used in thickening and washing has a considerable effect on the wash result i.e. the amount of interfering substances remaining in the pulp. Effective washing of the pulp significantly reduces the amount of interfering substances being carried to the paper and board machine. Due to the lowered content of dissolved substances both the risk for deposits and microbiological problems is decreased, whereupon the paper or board machine and processes thereof remain cleaner. As a consequence, the machine runnability is improved and the end product quality is better. In addition, the need for additive agents possibly needed in the process, such as fixing chemicals and retention agents, is decreased, which in turn lowers the running costs and simplifies the process. A problem with the washing is that as a consequence of the washing, the interfering substances concentrate strongly to the pulp making process, from which water is typically removed to the effluent treatment station at approximately 10 m³ per mass ton. This amount of water is replaced by white water brought in from a paper or board mill. When the amount of water removed from the process and consequently fresh water brought into the process constantly decreases, such a problem arises that the washing of the pulp no longer succeeds, but the quality of the pulp diminishes considerably and a great amount of interfering substances are carried with the pulp to the paper and board mill. Consequently, the runnability of the paper and board machine is considerably weakened.

In the treatment of white water of pulp making i.e. in removing the concentrated interfering substances from the white water of the pulp making process, micro flotation and possibly evaporation is used in some applications. In solutions according to prior art, the white water to be treated is taken to the treatment from the press after pulp bleaching. The clean water produced in the treatment is returned to the pulp making process by counterflow principle. Said techniques are, in principle, workable solutions, but they both have their weaknesses.

Micro flotation is at its best in particle separation. Colloidal pitch can also be removed by it to some extent. Colloidal substances do not, however, settle too well in clarification, and their removal is not very extensive in flotation or micro flotation without using large amounts of additive agents to separate said substances, usually pitch, from the water fraction. Use of polymers acting as additive agents increases the system running costs greatly. In addition, when overdosed, the polymers hinder, dirt and load the rest of the process.

The problem with the evaporation is, on the other hand, very high investment and operational costs. Evaporation surfaces are easily blocked because of fibres and interfering substances, so in order to work it needs an effective pre-treatment, the like of which, using membrane filtration has been proposed in some contexts. In addition, the problem with evaporation is that the evaporation concentrate includes all salts and ions, which prevent the fraction being burned in normal boilers. Consequently destroying the concentrate requires costly special arrangements.

In addition, in the publication SE 439 940 it is shown the use of membrane filtration to remove macromolecular substances and to return micromolecular substances and non-used bleaching agents back to the process from the process water of a refiner bleaching process based on peroxide bleaching. With the solution described in the publication SE 439 940 it may be possible to separate some part of the organic dissolved and colloidal substances included in the process water from the rest of the process water. But because in the solution according to the publication, bleaching agents have been added to the pulp, a significant part of the extractives are dissolved in the process water, the removal of which with a sufficient efficiency is not possible with membrane filtration.

In addition, a problem with the solution according to the publication is that because the process water separated from the pulp by a press is led directly to the membrane filter, a significant amount of valuable and useful fibre for paper making is also removed from the process.

The object of the method and arrangement according to the present invention is to remove or at least significantly reduce the problems arising from the aforementioned prior art, and to propose a method and arrangement in the making of mechanical pulp, with the help of which the quality of the white waters can be controlled more easily than before.

In addition, the object of the method and arrangement according to the present invention is to enable the reduction in quantity of dissolved and colloidal organic substances in the white water of pulp making.

In addition, the object of the method and arrangement according to the present invention is to intensify the pulp washing and consequently reduce the amount of fresh water being brought into the pulp making.

Furthermore, the object of the method and arrangement according to the present invention is to describe a method and arrangement in the making of pulp, with which the treatment of the white water of the pulp making process can be carried out with reasonable investment and operating costs.

In addition, the object of a very preferable method and arrangement according to the present invention is to enable the burning of the effluent concentrate removed from pulp making process water.

To realise i.e. the aforementioned objects, the method and arrangement according to the invention, is mainly characterised by what is presented in the characterising parts of the annexed independent claims.

In a typical method according to the present invention the treatment comprises at least steps, where process water filtrate separated from the pulp to be made by a press located before bleaching, is led to pre-treatment, where elongated fibres are fractionated from the process water to be treated. After this, the filtrate that has passed the pre-treatment is led to the membrane filtration, where at least part of the organic dissolved and colloidal substances included in the process water are separated from the rest of the process water. Finally, the concentrate produced in the membrane filtration i.e. the colloidal and dissolved substances separated from the process water, are led to further treatment and the permeate i.e. the process water that has passed the membrane filtration is led back to the pulp making process.

In this context the filtrate being led to the pre-treatment means the process water separated from the pulp by a press located before the bleaching process i.e. a bleaching press. The bleaching press can be, for example, a wire press, screw press, roller press or the like. Fractionating the filtrate, in this context, means dividing the filtrate in parts in a desired way i.e. in this case in a way, such that the elongated fibres are separated from the process water. According to one preferred embodiment of the invention, the separated fibres are led back to the pulp making process, for example, to a white water tank.

In one preferred method according to the present invention the membrane filtration is carried out by using membranes, whose retention capacity is 200-150,000 g/mol.

In other words, the filtration is carried out by using ultrafiltration and/or nanofiltration membranes. In some applications, reverse osmosis membranes can also be used.

Very preferably, the membrane filtration is carried out by using membranes, whose retention capacity is approximately 20,000-150,000 g/mol. Then the membrane filter permeates a main part of the inorganic salt ions, whereupon the membrane filter concentrate can be treated further i.e. disposed of by burning as such or, for example, mixed with some suitable supporting medium, such as saw dust or wood bark.

A typical arrangement according to the present invention in making mechanical pulp to reduce the amount of organic dissolved and colloidal substances in pulp making process water by treating a part of the process water comprises at least:
means for leading the process water filtrate, separated from the pulp being made with a press located before bleaching, to a pre-treatment means,
pre-treatment means for fractioning the elongated fibres from the process water being treated,
means for leading the filtrate, which has passed the pre-treatment means, to the membrane filtration means,
membrane filtration means for separating at least a part of the organic dissolved and colloidal substances included in the process water from the rest of the process water, and
means for leading the membrane filtration concentrate i.e. colloidal and dissolved substances separated from the process water to further treatment, and means for leading the permeate i.e. the process water passed through the membrane filtration back to the pulp making process.

In one preferred arrangement according to the present invention, the pre-treatment means comprise one or more pressure screens. The advantage of using a pressure screen as pre-treatment means is the low cost, small size and stable functioning.

In one preferred arrangement according to the present invention, the membrane filtration means comprise at least one membrane filter. Very preferably the membrane filtration means comprise several membrane filters, which are arranged in series. Very preferably the membrane filtration means comprise at least two membrane filter sets arranged in parallel. By increasing the number of membrane filters, the filtering capacity can be increased and thus larger amounts of process water can be treated. By arranging the membrane filters in series, membranes with smaller retention capacity can be used first and gradually increase the retention capacity of membranes used in filters. Then the risk of a membrane clogging is decreased and even the smallest interfering substances can be removed from the process water efficiently and reliably.

In one preferred arrangement according to the present invention, the retention capacity of the membrane filter is 200-150,000 g/mol. Very preferably the retention capacity of the membrane filter is 20,000-150,000 g/mol.

One preferred arrangement according to the present invention comprises means for mixing the membrane filtration concentrate into a supporting medium, for example, wood bark and/or saw dust. Then the membrane filtration concentrate having a high water content can be mixed with a supporting medium, whereupon burning of the concentrate is economical and possible in bark boilers located in many paper and board mills. An arrangement according to the present invention can, in addition, comprise means for pelletizing the concentrate and the supporting medium, whereupon the pelleted concentrate can be transported to be burned elsewhere. The membrane filtration concentrate has a very high fuel value, because of, for example, the pitch contained in the concentrate.

The method and arrangement according to the present invention realises, that by taking the process water to be treated from the pulp making process before feeding the bleaching chemicals, the chemicals typically used in bleaching have not raised the pH value of the pulp and thus dissolved the extractives but the extractives included in the process water are in such colloidal form, that they can be removed from the process water by using membrane filtration. Consequently, one of the greatest advantages of the method and arrangement according to the invention is, that a very large part of the harmful extractives can be removed from the process water, and there is no need to use separate chemicals to remove them.

In addition, one of the advantages of the method and arrangement according to the present invention is that by using membrane filtration permeate in pulp washings, the pulp washing can be intensified and thus reduce the amount of new white water taken into the pulp making from the paper machine. This is of the utmost importance when striving for a reduction in water usage in paper and board manufacture, and the amount of water available for pulp washing from a paper and board machine decreases.

In addition, one of the advantages of the method and arrangement according to the present invention is that with membrane filtration in mechanical pulp making, the amount of dissoluble and colloidal substances transferred to the paper machine with the pulp can be reduced.

In addition, one of the advantages of the method and arrangement according to the present invention is that because the interfering substance content of the pulp being transferred to a paper or board machine is lower, the need for additive agents is decreased. For example, the need for expensive cationic fixing chemicals in some applications may be reduced even by 50%.

In addition, when the cleanness of the paper or board machine process is improved, the contamination of the paper or board machine itself is minimised and thus the need for expensive cleaning interruptions is decreased

Furthermore in addition, in the paper or board machine process, the paper or board quality problems caused by interfering substances are also decreased.

In the following, the invention is described more closely with reference to the appended drawing, in which

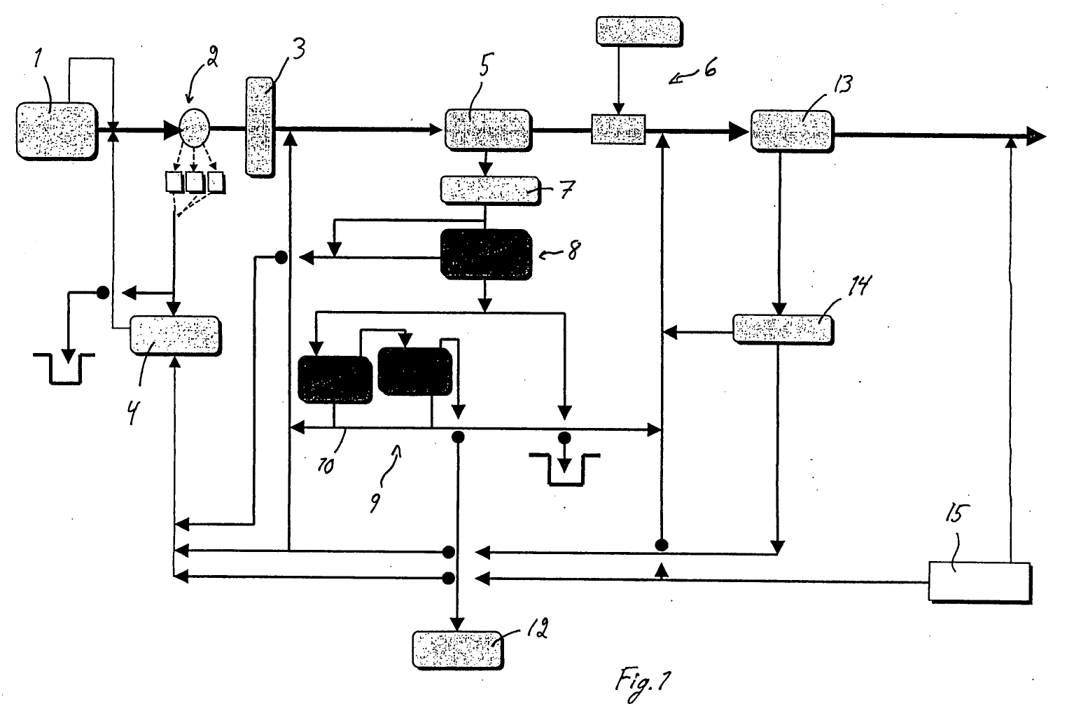

FIG. 1 schematically illustrates a flow diagram of membrane filtration as a part of pulp making, and

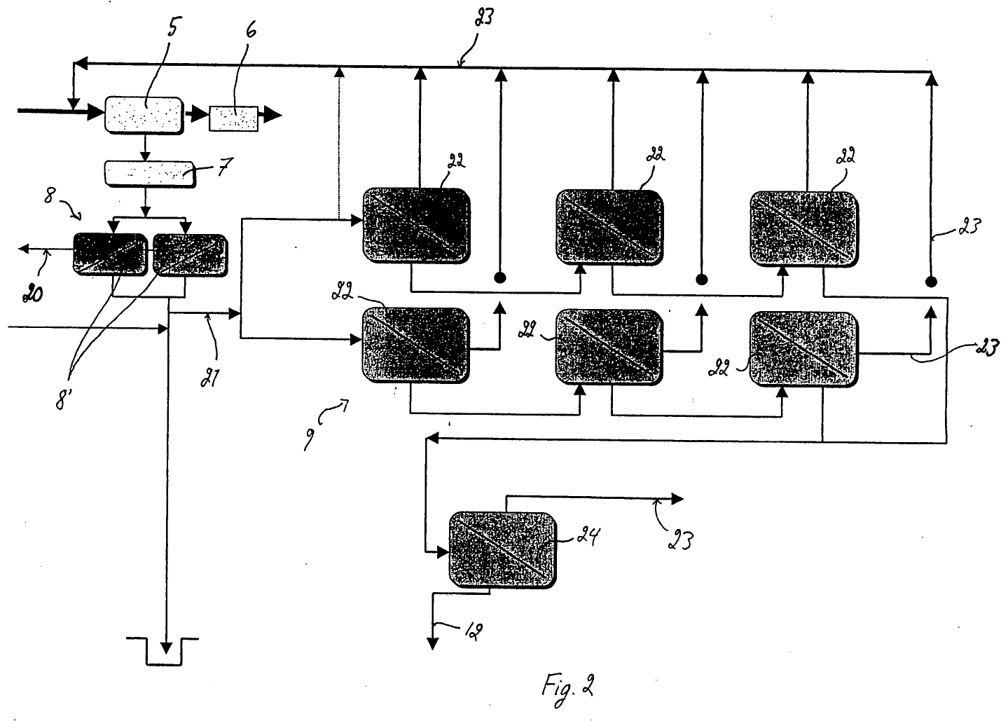

FIG. 2 schematically illustrates the membrane filtration flow diagram of FIG. 1.

FIG. 1 schematically illustrates, by way of an example, a pulp making flow diagram. As FIG. 1 illustrates, from mechanical pulp making of pulp i.e. defibration, for example, from grinding 1 or refinery, pulp is produced, whose consistency is typically approximately 0.1-0.8%. The mechanical pulp making process to be used can be, for example, thermomechanical pulping (TMP), grinding (GW/SGW), pressurised grinding (PGW) or thermo grinding (TGW). Mechanical pulp making process can also be chemi-thermomechanical pulping (CTMP) or chemi-mechanical pulping (CMP), which do not use bleaching agents in refining. From defibration the pulp is led to thickening 2, for example, to a disk filter. In the thickening the pulp consistency is typically raised to approximately 6-12% and the pulp is typically led to an intermediate storage 3. The filtrate of the thickening is led to a white water tank 4 and from there back to the pulp making process. After the intermediate storage 3 the pulp is typically diluted to an approximately 4-8% consistency and led to a bleaching press 5. If, in the pulp making process, it is not used an intermediate storage, where it is preferable to store the pulp in as high consistency as possible in order to save space, the pulp can be thickened directly to a 4-8% consistency in the thickening.

At the bleaching press 5, such as a wire or screw press for example, the pulp consistency is typically raised to approximately 35%. From the bleaching press 5 the pulp is further led to bleaching 6, where bleaching agent is added to the pulp. The pulp filtrate is led from the bleaching press to a first filtrate tank 7 and from there further to the treatment according to the present invention. In the bleaching 6, bleaching chemicals are fed to the pulp to improve the quality properties of the pulp.

According to the present invention the treatment is carried out by leading bleaching press filtrate directly from the bleaching press or as illustrated in FIG. 1, through a first filtrate tank to a pre-treatment 8. In the pre-treatment 8, the elongated fibres are separated from the filtrate, which fibres are returned back to the pulp making process through the white water tank 4. The part of the filtrate that has passed through the pre-treatment 8 is led to a membrane filtration 9. As FIG. 1 illustrates, a membrane filtration permeate 10 is led back to the pulp making either to dilute the pulp after the intermediate storage 3 and/or to dilute the pulp after the bleaching 6. A membrane filtration concentrate 11 i.e. the dissolved and colloidal interfering substances removed from the filtrate, are led to a further treatment 12. The pre-treatment and membrane filtration of the filtrate are illustrated in FIG. 2 in more detail.

After the bleaching 6, the pulp is typically diluted to an approximately 5% consistency and led to a washing press 13 i.e. the so-called dewatering press, where the pulp is typically pressed to over 30% consistency. The washing press filtrate is led to a second filtrate tank 14, from which the washing filtrate can be used to dilute the pulp before the washing press and/or lead the filtrate back to the pulp making process through the white water tank 4. After the washing press 13 the pulp is typically diluted with a clear filtrate 15 of the paper or board machine to an 8% consistency and led to the paper or board machine. The clear filtrate of the paper or board machine can be used, as illustrated in FIG. 1, also for example, to dilute pulp before bleaching- and/or the washing press.

FIG. 1 illustrates only by way of an example and very schematically a pulp making process function diagram. Pulp consistencies in different stages are only exemplary and can vary between different processes. Substantial, from the point of view of the present invention is that the filtrate derived before bleaching is treated by using membrane filtration. In some applications, in addition to the treatment according to the present invention, also for example, washing press filtrate treatment can be used, for example, by using membrane filtration and/or micro flotation.

FIG. 2 schematically and by way of an example illustrates a membrane filtration arrangement according to the present invention. In FIG. 2, reference numbers from FIG. 1 are used when appropriate. As FIG. 2 illustrates, the bleaching press 5 filtrate is led to a first filtrate tank 7 and from there further to pre-treatment 8. The pre-treatment 8 comprises two pressure screens 8′ arranged in parallel, with which the solid matter i.e. mainly elongated fibre is separated from the rest of the mixture. The solid matter is returned back to the pulp making process along line 20. At least part of the mixture passed through the pre-treatment 8 i.e. pre-treatment accept, is directed to the membrane filtration 9 along line 21. Membrane filtration 9 comprises according to FIG. 2, a first membrane filtration stage and a second membrane filtration stage.

The first membrane filtration stage comprises two sets of three consecutive membrane filter 22 sets, arranged in parallel i.e. six membrane filters in total. Consecutively arranged membrane filters 22 are arranged thus, that the concentrate from the previous membrane filter is led as an input for the next membrane filter. The permeate of the membrane filters 22 is led to a permeate line 23. The concentrate from the last membrane filters is led to the second membrane filtration stage. The retention capacity of the membranes of the membrane filters used in the first membrane filtration stage is approximately 30,000 g/mol.

The second membrane filtration stage comprises one membrane filter 24, where the retention capacity of the membrane filter's membranes is approximately 100,000 g/mol. Also, the permeate from the second membrane filtration stage is led to the permeate line 23. Along the permeate line 23, the membrane filtration permeate can be led back to the pulp making process, i.e., for example, as FIG. 2 illustrates, to the pulp dilution before the bleaching press. The concentrate from the second membrane filtration stage is led to further treatment 12.

In the first and second membrane filtration stage it is possible to use as a membrane filter a membrane filter as described, for example, in the patent publication U.S. Pat. No. 6,209,727. In addition, the size and the retention capacity of the membranes used can vary in different applications.

Due to the treatment technique according to the present invention utilising membrane filtration, to the pulp making process it can be returned water which in practise has no solid matter, bacteria or extractives. In addition, using membrane filtration according to the present invention, the charge of the water being returned to the pulp process is lowered by approximately 70% and COD (Chemical Oxygen Demand) by approximately 50%. Thus the return water used for pulp washing in pulp making does not increase the extractive content of the pulp being made and the washing off of the extractives coming with the pulp away from the process is improved. Consequently, using membrane filtration according to the present invention, the extractives can be led out from the pulp making process through membrane filtration concentrate.

The second membrane filtration stage concentrate includes large amounts of organic fines and colloidal material, whose fuel value is high. In some processes the concentrate cannot however be burned as such, because of the high water content of the concentrate. Then the concentrate can be further treated by, for example, mixing the concentrate into a supporting medium, such as for example, wood bark or saw dust or by evaporation, whereupon burning is economical and possible in bark boilers used nowadays in many mills. If burning of the concentrate is not possible in the direct vicinity of the pulp making process, the mixture of the concentrate and supporting medium can be, for example, pelletized and transported to be burned elsewhere.

Previously typically, in the final treatment of the pulp making process water, the concentrate produced by using nanofiltration and reverse osmosis membranes as well as evaporation have included large amounts of inorganic salts, which have prevented the burning of the concentrate. Because in one very preferred embodiment according to the present invention a filtering membrane with a retention capacity of approximately 20,000-100,000 g/mol is used, the inorganic salt ions pass through the filtering membrane. Thus the amount of harmful salts in the concentrate to be burned is low and thus they don't usually constitute a problem to the burning equipment. To separate toxic colloidal substances from the effluent with membrane filtration technique according to the present invention also improves the efficiency of possible biological treatment of the effluent. In the burning process, the toxic colloidal substances do not constitute a problem.

It is not intended to limit, in any way, the invention to the embodiments of the description above, but it can be varied within the scope of the inventive idea described in the claims.

1. A method in making of mechanical pulp, where the amount of organic dissolved and colloidal substances is reduced in the pulp making process water by treating a part of the process water, characterised in that the treating comprises at least the following steps:
process water filtrate separated from the pulp to be made by a press located before bleaching, is led to pre-treatment, where elongated fibres are fractionated from the process water to be treated,
the filtrate that has passed the pre-treatment is led to membrane filtration, where at least part of the organic dissolved and colloidal substances included in the process water are separated from the rest of the process water, and
membrane filtration concentrate, i.e. the colloidal and dissolved substances separated from the process water, are led to further treatment and the permeate i.e. the process water that has passed the membrane filtration is led back to the pulp making process.

2. A method according to claim 1, characterised in that the elongated fibre's fraction separated in the filtrate in the pre-treatment is led back to the pulp making process.

3. A method according to claim 1, characterised in that the membrane filtration is carried out by using membranes whose retention capacity is 200-150,000 g/mol.

4. A method according to claim 3, characterised in that the membrane filtration is carried out by using membranes whose retention capacity is approximately 20,000-150,000 g/mol.

5. An arrangement according to claim 1, characterised in that membrane filtration concentrate is disposed of by burning.

6. An arrangement in making of mechanical pulp to reduce the amount of organic dissolved and colloidal substances in the pulp making process water by treating a part of the process water characterised in that the arrangement comprises at least:
means for leading the process water filtrate, separated from the pulp being made with a press located before bleaching, to a pre-treatment means,
pre-treatment means for fractioning the elongated fibres from the process water being treated,
means for leading the filtrate, which has passed the pre-treatment means, to the membrane filtration means,
membrane filtration means for separating at least part of the organic dissolved and colloidal substances included in the process water from the rest of the process water, and
means for leading the membrane filtration concentrate i.e. colloidal and dissolved substances separated from the process water to further treatment, and means for leading the permeate i.e. the process water passed through the membrane filtration back to the pulp making process.

7. An arrangement according to claim 6, characterised in that the pre-treatment means comprise one or more pressure screens.

8. An arrangement according to claim 6, characterised in that the membrane filtration means comprise at least one membrane filter.

9. An arrangement according to claim 6, characterised in that the membrane filtration means comprise several membrane filters arranged in series.

10. An arrangement according to claim 9, characterised in that the membrane filtration means comprise at least two membrane filter sets arranged in parallel.

11. An arrangement according to claim 8, characterised in that the retention capacity of the membrane filter is 200-150,000 g/mol.

12. An arrangement according to claim 11, characterised in that the retention capacity of the membrane filter is 20,000-150,000 g/mol.

13. An arrangement according to claim 6, characterised in that the arrangement comprises means for mixing the membrane filtration concentrate into a supporting medium, for example, wood bark and/or saw dust.
